(19) United States
(12) Patent Application Publication
(10) Pub. No.: US 2009/0150240 A1
(43) Pub. Date: Jun. 11, 2009

(54) LOYALTY TRANSACTIONS SYSTEM AND METHOD

(76) Inventor: Francis Patrick Phillips, East Bentleigh (AU)

Correspondence Address: HOLLAND & HART, LLP, P.O BOX 8749, DENVER, CO, 80201, US

(21) Appl. No.: 12/251,278

(22) Filed: Oct. 14, 2008

(30) Foreign Application Priority Data
Oct. 15, 2007 (AU) 2007905644

(51) Int. Cl. G06Q 30/00

(52) U.S. Cl. 705/14

(57) ABSTRACT

A loyalty transactions system including defining a plurality of teams of service or product providers having at least two favourable or selectable forms: providing a customer with a choice of having loyalty to one of the at least two teams of service or product providers in one of the favourable or selectable forms; wherein loyalty by the customer with one of the service or product providers of one team provides loyalty offers and will allow redemption of accepted loyalty offers or traded loyalty offers with that or any other of the service or product providers of the one team.

### FIELD OF THE INVENTION

The invention generally relates to a system and method of a loyalty transaction system. In particular the invention relates to a system and method in which a participant of a program is encouraged to act with a certain loyalty or encourage loyalty from others.

### BACKGROUND

Customer incentive programs, such as loyalty programs, issue points to customers (i.e., participants) as a reward for certain activities such as the purchase of certain products or services or performing a certain action. These points create a loyalty or affinity with the customer and encourage the customer to continue a desired behaviour. The customer is motivated through some type of reward offering which allows the customer to redeem the points for rewards.

Usually such loyalty programs provide the customer with a limited listing of rewards from selected redemption product or service providers in the form of merchandise, certificates, or other products or services (hereafter referred to as rewards) and the number of points needed to obtain one of the rewards from the list. In general, the selected redemption product or service providers are a limited number which have some type of relationship, contractual or otherwise, with the loyally program. The customer selects a reward for purchase with the points and indicates to the loyalty program that the particular product or service has been selected. The loyalty program obtains the product or service on behalf of the customer from one of the limited number of selective redemption product or service providers and provides it to the customer. The points needed to obtain the reward (e.g., a new flight ticket) are deducted from the customer's point account.

However the loyalty is associated with a single product or service provider whereas the redemption is through that product or service provider or a selection of far and wide

The principle of providing loyalty to one party can be lost by the redemption being with another party to which the customer has no loyalty.

It is an object of the invention to overcome or at least ameliorate the problems of the prior art. In particular it is an object of the invention to provide a loyalty program that encourages a consistent loyalty to a range of service providers.

### SUMMARY

In accordance with the invention there is provided a method of providing loyalty including
defining a plurality of teams of service or product providers having at least two favourable or selectable forms;
providing a customer with a choice of having loyalty to one of the at least two teams of service or product providers in one of the favourable or selectable forms;
wherein loyalty by the customer with one of the service or product providers of one team provides loyalty points and will allow redemption of loyalty points with that or any other of the service or product providers of the one team.

The plurality of teams can be geographically defined. For example the teams can be the odd number side of the street and the even number side of the street. In this way the system is engendering loyalty but competition to community commercial centres.

The plurality of teams can be defined by personal characteristics. For example the teams can be male/female and therefore the system is engendering loyalty but competition due to different perceived gender styles.

The plurality of teams can be defined by social or moral issues. For example the teams can be green industries by growing a tree to compensate for greenhouse effects or green industries that reduce greenhouse effects and therefore the system is engendering loyalty but competition due to different perceived green styles.

The plurality of teams can be a combination of the above.

The plurality of teams can comprise three teams whereby two teams are defined by different favourable or selectable forms and the third team wishes to not be limited by the different favourable or selectable forms but rather is inclusive of both different favourable or selectable forms.

The customer can be one of the service or product providers of one team.

The customer can earn loyalty offers by purchases at a product or service providers of their team. However the customer can receive bonus loyalty offers from product or service provider of their team. This encourages further

The bonus loyalty offers can be in the form of offers. The offers can have an expiry date.

A register can be used to register customers and product or service providers.

The customer can receive free loyalty point offers.

The invention addresses the above needs as well as others by providing a method and system for permitting a participant of the loyalty program to transact purchases with a product or service provider using loyalty offers or a combination of loyalty offers and currency rather than currency alone with a product or service provider in the same team.

The invention particularly addresses the needs for permitting a loyalty program participant to purchase products or services according to a desired favourable or selectable form of product or service provider by providing the ability for a system and method which integrates to the loyalty system indicating what the provider is attempting to follow in principle. In addition, it provides fulfillment capability without having to involve highly detailed analysis by third party organizations. The invention enables customers and providers to get greater satisfaction and more immediate gratification from their loyalty program regardless of their preferred method of interaction.

In one form, the invention comprises a system for use by a participant of a program which awards points to the participant, wherein the awarded points are maintained in a point account for the participant. The system permits the participant to transact a purchase using the awarded points with a product or service provider system which transacts purchases according to the principle of the favourable or selectable feature of the team.

A register can be used which interfaces with the product or service provider system and uses a program account for use in recording transactions between the participant and the register, wherein the register includes instructions for receiving participant loyalty acceptance transactional information from the participant and providing the received participant loyalty acceptance transactional information to the register and further the register is adapted to provide the received participant loyalty acceptance transactional information to the product or service provider system, and the register is adapted to receive product or service provider loyalty offer transactional information from the product or service provider system and adapted to provide the received product or service provider loyalty offer transactional information to the register and the register includes instructions for receiving product or service provider loyalty offer transactional information from the register and for providing the received product or service provider loyalty offer transactional information to the participant, whereby from the perspective of the participant, the participant uses the register to conduct a purchase transaction with the product or service provider system based in whole or in part on the points in the participant's accepted loyalty offer account and from the perspective of the product or service provider system, the product or service provider system conducts the purchase transaction with the participant based on the program account. In another form, the invention is a method for use by a participant of a program which awards points to the participant, wherein the awarded points are maintained in a point account for the participant. The method permits the participant to transact a purchase using the awarded points with a product or service provider system which transacts purchases in currency.

The method for use by a participant of a program can awards loyalty offers to the participant, wherein the awarded loyalty offers are maintained in a loyalty offer account for the participant and the method permits the participant to transact a purchase using the awarded loyalty offer with a product or service provider system which transacts purchases in accordance with the loyally offer.

The method can comprise the steps of:
a. providing an interface between the participant and the product or service provider system,
b. converting a loyalty offer from the product or service provider to an acceptance request from the participant, based in whole or in part on history of loyalty, into a corresponding acceptance of loyalty offer based on whether the participant's loyalty account has sufficient loyalty credits to qualify for the loyalty offer; and
c. causing the acceptance of the loyalty offer to be deducted from the participant's account in response to a purchase of product or service from the product or service provider;
whereby the amount of loyalty offers able to be accepted by a participant is limited due to time limitations and/or value limitations.

The invention also provides a system for permitting a participant to transact a purchase using awarded loyalty offers with a product or service provider system which transacts purchases in accepted loyalty offers and currency, the system comprising:
a. a loyalty program which awards or offers loyalty offers to a participant, wherein the awarded or offered loyalty offers are maintained in a loyalty offer account for the participants
b. the loyalty program allowing trading of accepted loyalty offers to another participant, wherein the traded loyalty offers are maintained in a loyalty offer account for the another participant;
c. a register for interfacing with the product or service provider system;
d. a loyalty account for use in recording accepted and traded loyalty transactions;
e. a user interface for providing an interface between the participants and the register;
whereby a participant can purchase a product or service from the product or service provider using awarded, accepted or traded accepted loyalty offers and currency.

### BRIEF DESCRIPTION OF THE DRAWINGS

In order that the invention is more readily understood an embodiment will be described by way of illustration only with reference to the drawings wherein:

FIG. 1 is a diagrammatic view of a loyalty system in accordance with a first embodiment of the invention;

FIG. 2 is a diagrammatic view of a loyalty system in accordance with a second embodiment of the invention; and

FIG. 3 is a diagrammatic view of a transactional process of a loyalty system in accordance with an embodiment of the invention.

### DETAILED DESCRIPTION

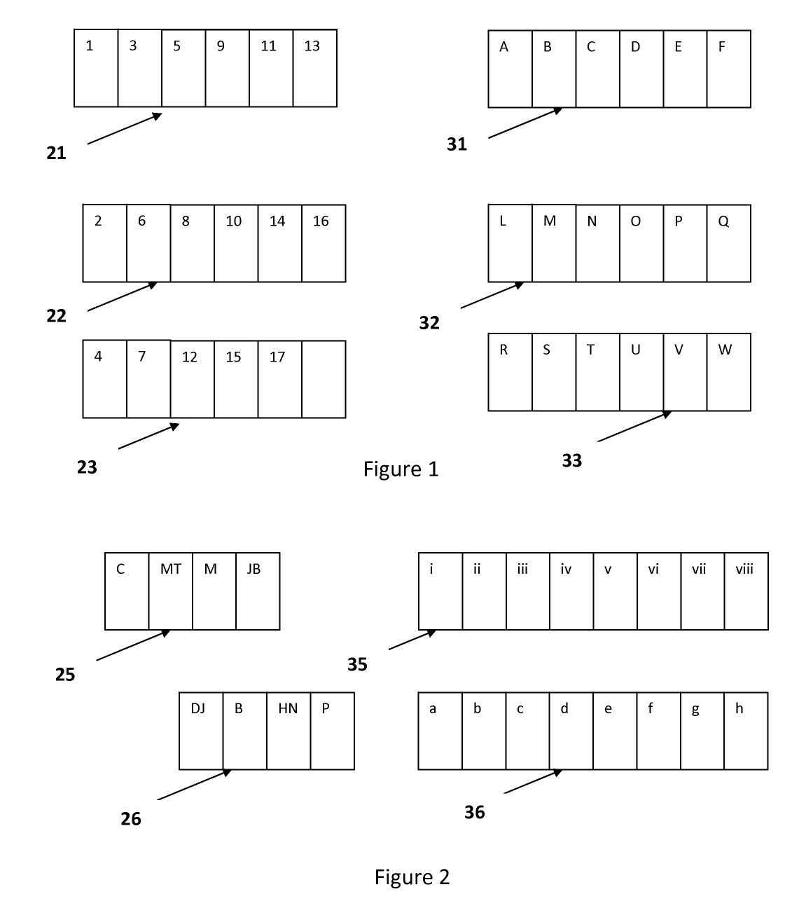

Referring to FIG. 1 of the drawings in one form of the invention there are three teams of product and service providers 21, 22 and 23 defined by one team 21 being the odd number side of the street and another team 22 being the even number side of the street while a third team 23 opt out and wish to be not defined by odd or even. In this way the system is engendering loyalty but competition to community commercial centres.

Generally management will determine the team that they wish to be aligned.

Customers A-F, L-Q, and R-W can register as members of teams 31, 32, 33 to be associated with one of the teams 21, 22, 23 of product and service providers. Details of the teams of product and service providers and details of the members for each team of product and service providers can be retained on a register 15 that preferably is an electronic website register.

In another form of the teams as shown in FIG. 2 there are two teams of product and service providers 25 and 26 defined by one team 25 of businesses C, MT, M and JB offering no plastic bags for customers as their green movement but offering reused boxes and another team 26 of businesses DJ, B, HN, and P offering no plastic bags for customers as their green movement but offering reusable bags at token cost. In this way the system is engendering loyalty but competition to customers while allowing customers to determining their preferred way of adding to the green movement.

Members can obtain loyalty offers by undertaking transactions with product and service providers of their team. The earned bonus loyalty offers can have limited life such as three months.

The product and service providers can provide bonus loyalty offers.

Members receive daily a free bonus loyalty offer from one or more product and service providers on their team and also receive a single acceptance which expires that day. The member must therefore take advantage of the single acceptance by aligning with a particular free bonus loyally that has been offered by a product and service providers on their team and accepting that offer. After offer and acceptance has occurred the transaction is recorded on the Register 15.

However the offer can be traded to other potential customers 41, 42, which are identified as Trader B and Trader C. Trader B can undertake trade of the accepted loyalty offer from Customer A and could make use of the loyalty offer with the product and service provider 21 or can undertake further trade to Trader C who makes use of the loyalty offer with the product and service provider 21.

It is possible that the loyalty offer is able to be used at another of the members of the same team 21 of service and product suppliers.

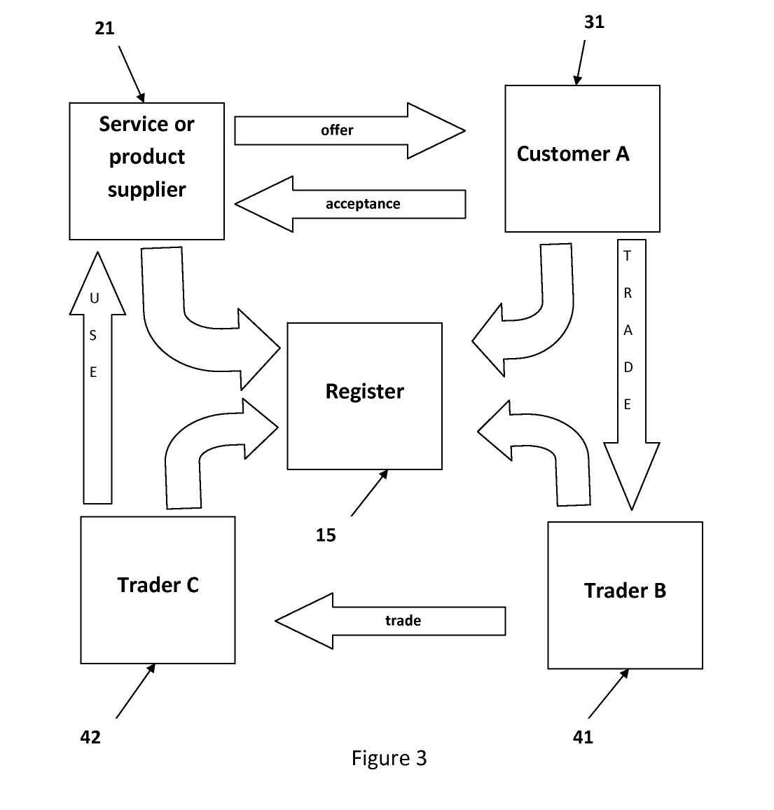

The trading transactions are also maintained on the Register as shown by the transactional paths shown in FIG. 3.

The benefit of the trading of the accepted loyalty offers is that Customer A is spreading the word of the benefit of the Service or product supplier to further potential customers generally because of the favourable or selectable form of the member of the team chosen by Customer A. Therefore not only is the Service or product supplier 21 generating new contacts by the expansion of the possible customers but the goodwill of the Service or product supplier 21 is being improved.

Another substantial benefit is that the accepted offer is being used by Trader C and therefore the business provided by the Service or product supplier 21 can be more readily predicted due to the Register of accepted offers.

Customer A is also more inclined to accept offers by the Service or product supplier 21 since if for any reason Customer A no longer wishes to make use of the accepted offer they can trade it to another.

In a still further adoption of the system the teams 21 and 31 can be purely non-commercial entities such as a neighborhood loyalty system. In this way, teams of suppliers can be formulated by supplying details of ethical, personal, professional or selective qualities or preferences and services or products that would wish to be offered to others. Other receiving teams can be selected by the people in neighborhood registering themselves to a team that could be of interest and has a preferred ethical, personal, professional or selective qualities or preferences.

Therefore transactions or trading of accepted offers can occur in order to engender neighborhood and community spirit and assistance.

While we have described herein embodiments for a loyalty transaction system and method, it is further envisaged that other embodiments of the invention could exhibit any number and combination of any one of the features previously described. However, it is to be understood that any variations and modifications can be made without departing from the spirit and scope thereof as defined in the following claims.

What is claimed is:

1. A loyally transactions system including
a. defining a plurality of teams of service or product providers having at least two favourable or selectable forms,
b. providing a customer with a choice of having loyally to one of the at least two teams of service or product providers in one of the favourable or selectable forms;
c. wherein loyalty by the customer with one of the service or product providers of one team provides loyalty offers and will allow redemption of accepted loyally offers with that or any other of the service or product providers of the one team.

2. A loyally transactions system according to claim 1 wherein the plurality of teams are geographically defined, such that the system is engendering loyalty but competition to community commercial centres.

3. A loyally transactions system according to claim 1 wherein the plurality of teams are defined by personal characteristics such that the system is engendering loyalty but competition due to different perceived gender styles.

4. A loyalty transactions system according to claim 1 wherein the plurality of teams are defined by social or moral issues such that the system is engendering loyalty but competition due to different perceived social or moral styles.

5. A loyalty transactions system according claim 1 wherein the plurality of teams is a combination of selection criteria.

6. A loyalty transactions system according to claim 1 wherein the plurality of teams comprises three teams whereby two teams are defined by different favourable or selectable forms and the third team wishes to not be limited by the different favourable or selectable forms but rather is inclusive of both different favourable or selectable forms.

7. A loyalty transactions system according to claim 1 wherein the customer is aligned with the service or product providers of one team.

8. A loyalty transactions system according to claim 1 wherein the customer earns loyalty offers by purchases at a product or service providers of their team.

9. A loyalty transactions system according to claim 1 wherein the customer can receive bonus loyally offers from product or service provider of their team.

10. A loyalty transactions system according to claim 9 wherein the bonus loyalty offers can have an expiry date and must be accepted before that date.

11. A loyalty transactions system according to claim 1 including a register which is used to register customers and product or service providers.

12. A loyalty transactions system according to claim 1 including a register which is used to register customers and product or service providers.

13. A loyalty transactions system according to claim 1 wherein the customer can receive free loyalty offers.

14. A method for permitting a participant of a loyalty program to transact purchases with a product or service provider of a selected team using accepted and/or transferred loyalty offers or a combination of accepted and/or transferred loyalty offers and currency rather than currency alone with a product or service provider in the same team whereby a loyalty program participant can purchase products or services according to a desired favourable or selectable form of product or service provider by providing the ability for a system and method which integrates the loyalty system with what the product or service provider of the selected team is attempting to follow in principle.

15. A method according to claim 14 for use by a participant of a program which awards or offers loyalty offers to the participant, wherein the awarded or accepted loyalty offers are maintained in a loyalty offers account for the participant and the system permits the participant to transact a purchase using the awarded or accepted loyalty offers with a product or service provider system which transacts purchases according to the principle of the favourable or selectable feature of the team.

16. A method according to claim 15 including a register which interfaces with the product or service provider system and uses a program account for use in recording transactions between the participant and the register,
a. wherein the register includes instructions for receiving participant loyalty acceptance transactional information from the participant and providing the received participant loyalty acceptance transactional information to the register and further the register is adapted to provide the received participant loyalty acceptance transactional information to the product or service provider system; and
b. the register is adapted to receive product or service provider loyalty offer transactional information from the product or service provider system and adapted to provide the received product or service provider loyalty offer transactional information to the register and the register includes instructions for receiving product or service provider loyalty offer transactional information from the register and for providing the received product or service provider loyalty offer transactional information to the participant,
whereby from the perspective of the participant, the participant uses the register to conduct a purchase transaction with the product or service provider system based in whole or in part on the points in the participant's accepted loyalty offer account and from the perspective of the product or service provider system, the product or service provider system conducts the purchase transaction with the participant based on the program account.

17. A method for use by a participant of a program which awards loyalty offers to the participant, wherein the awarded loyalty offers are maintained in a loyalty offer account for the participant and the method permits the participant to transact a purchase using the awarded loyalty offer with a product or service provider system which transacts purchases in accordance with the loyalty offer.

18. A method according to claim 14 comprises the steps of:
a. providing an interface between the participant and the product or service provider system;
b. converting a loyalty offer from the product or service provider to an acceptance request from the participant, based in whole or in part on history of loyalty, into a corresponding acceptance of loyalty offer based on whether the panicipant's loyalty account has sufficient loyalty credits to qualify for the loyalty offer; and
c. causing the acceptance of the loyalty offer to be deducted from the participant's account in response to a purchase of product or service from the product or service provider;
whereby the amount of loyalty offers able to be accepted by a participant is limited due to time limitations and/or value limitations.

19. A method according to claim 17 for permitting a participant to transact a purchase using awarded loyalty offers with a product or service provider system which transacts purchases in accepted loyalty offers and currency, the system comprising:
a. a loyalty program which awards or offers loyalty offers to a participant, wherein the awarded or offered loyalty offers are maintained in a loyalty offer account for the participant;
b. the loyalty program allowing trading of accepted loyalty offers to another participant, wherein the traded loyalty offers are maintained in a loyalty offer account for the another participant;
c. a register for interfacing with the product or service provider system;
d. a loyalty account for use in recording accepted and traded loyalty transactions;
e. a user interface for providing an interface between the participants and the register;
whereby a participant can purchase a product or service from the product or service provider using awarded, accepted or traded accepted loyalty offers and currency.
